(19) United States
(12) Patent Application Publication
(10) Pub. No.: US 2012/0287685 A1
(43) Pub. Date: Nov. 15, 2012

(54) CONVERTER

(75) Inventor: Marc Fahlenkamp, Geretsried (DE)

(73) Assignee: INFINEON TECHNOLOGIES AG, Neubiberg (DE)

(21) Appl. No.: 13/103,201

(22) Filed: May 9, 2011

(51) Int. Cl. H02M 1/36

(52) U.S. Cl. 363/49

(57) ABSTRACT

A converter may include a start-up circuit having a switch circuit coupled to a reference potential terminal and an input circuit coupled to an input voltage, wherein the input circuit is coupled to the start-up circuit such that in case that at least one of the input voltage is lower than a predetermined threshold and that the input voltage is substantially constant for a predefined time period, electrical charges stored in the input circuit are flowing through the switch circuit to the reference potential terminal.

### TECHNICAL FIELD

Various embodiments relate generally to a converter. Moreover, various embodiments relate to a converter including a circuit module providing discharge functionality for protective capacitors and start-up functionality for the converter.

### BACKGROUND

Switch-mode power supplies (SMPSs) which are powered through a power plug from by an AC grid may generally have the demand to decrease the voltage between contacts of the power plug within a defined period after the power plug has been removed from an electrical socket to a sufficiently low value which is defined by legal standards. The voltage at a power plug of a SMPS in its disconnected state is caused by charges located on the “X” class capacitors in the input filter of a SMPS. “X” class capacitors, also known as “X-caps” (caps being short for capacitors) are usually used in an input filter of an SMPS and coupled between the phases (or between hot and neutral) in order to attenuate differential modes of electromagnetic interferences.

Several approaches are viable in order to meet the requirements set by legal standards regarding the voltage at the power plug after withdrawal from an electric socket. There is an attempt to optimize two essential parameters: reduction of the power loss related to the discharge path of the X-caps and reduction of additional system costs for the discharge path.

One possible approach to meet the requirements is to discharge the X-caps passively via a resistor that is coupled in parallel to the X-caps. Although this approach offers the lowest system cost, it suffers from ohmic power loss in the resistor and hence has the worst performance with regard to its power efficiency. In addition, if a very low power consumption is to be reached with the SMPS in a “no-load” state (which illustratively represents a state in which substantially no load is coupled to the output of an SMPS), the choice of the capacity of the X-caps is restricted and thereby hinders the design of the input filter.

In another approach the X-caps are discharged via a parallel resistive path which can be opened or closed in an active manner by an additional IC (integrated circuit). This approach can be viewed as an optimized implementation of the passive discharge approach with regard to power loss. The use of a special IC, such as the “CAPZero” manufactured by Power Integration, the resistive discharge path can be actively closed, when the IC detects that the power plug of the SMPS has been disconnected to an AC power grid. However, this approach has the disadvantage of increased system costs caused by the IC. Despite reduced power loss approximately 5 mW are consumed by the IC during normal operation. This aspect might prove detrimental to reaching a “ZeroPower” consumption in a “no load” state.

In yet another approach the X-caps are discharged via an active, separate circuit. This approach offers the advantage of the possibility to freely set the discharge current, however, it involves increased system costs.

Another feature that might be included in SMPSs is a start-up functionality which ensures that e.g. some internal circuit in the form of an IC that might be shut down temporarily for reasons of efficiency, is reactivated once certain conditions are met. Such a functionality can be implemented into the main IC which or it can be implemented as an external independent circuit. An example for an internal implementation in an IC is the Green Mode Fairchild Power Switch FSB1×7H, which further offers sensing of the input voltage.

### SUMMARY

According to various embodiments, a converter is provided. The converter may include a start-up circuit including a switch circuit coupled to a reference potential terminal, an input circuit coupled to an input voltage, wherein the input circuit is coupled to the start-up circuit such that in case that at least one of the input voltage is lower than a predetermined threshold and that the input voltage is substantially constant for a predefined time period, electrical charges stored in the input circuit are flowing through the switch circuit to the reference potential terminal.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic of a converter in accordance with various embodiments;

FIG. 2 shows an implementation of the converter shown in FIG. 1 in accordance with various embodiments;

FIG. 3 shows another implementation of the converter in accordance with various embodiments; and

FIG. 4 shows an implementation of the converter in accordance with various embodiments with a switch circuit fully integrated in a controller.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

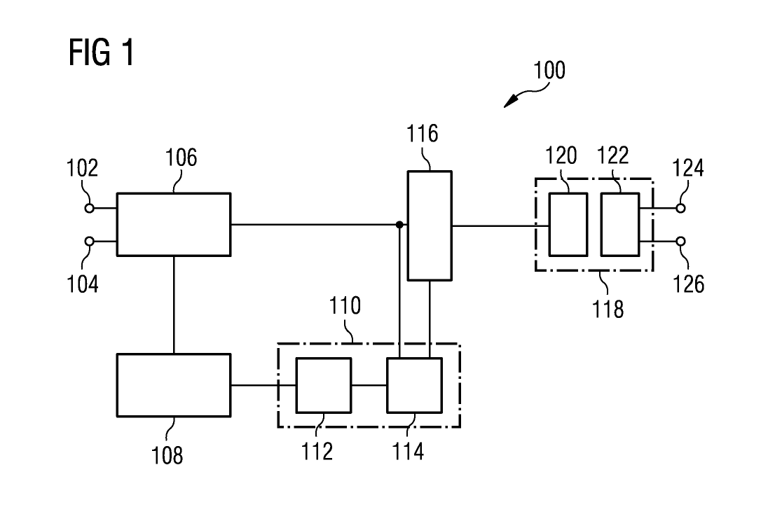

FIG. 1 shows a schematic of a converter 100 in accordance with various embodiments.

As shown in FIG. 1, the converter 100 according to various embodiments may include an input circuit 106 which is provided with a first input 102 and a second input 104. The inputs 102, 104 are used to supply an AC-voltage and/or AC-current (in the following, both terms will be used interchangeably) to the converter 100, wherein in general one or more inputs may be provided. The input circuit 106 may include a variety of functional elements, such as a rectifying circuit and/or a filtering circuit. The input circuit is coupled to a controller 116 which is configured to control the general operation of the converter 100. The input circuit 106 may be further coupled to a charge pump circuit 108. The charge pump circuit 108 may be coupled to a start-up circuit, for example to a state detection circuit 112 of the start-up circuit 110. The start-up circuit may further include a switch circuit 114, which may be coupled to an electrical path anywhere between the first input 102 or the second input 104 and the controller 116. The switch circuit may further be coupled to the controller 116 and/or to a reference potential. The converter 100 may further include a transformer 118 which may have a primary side 120 and a secondary side 122. The controller 116 may be coupled the primary side 120 of the transformer 118. The secondary side 122 may be provided with one or more, for example, as in this exemplary schematic, two outputs for providing a DC-voltage, a first output terminal 124 and a second output terminal 126.

It is to be noted that the schematic of a converter 100 shown in FIG. 1 is not exhaustive and merely presents a coarse schematic overview of a possible functional implementation of the converter in accordance with various embodiments. Further interconnections between the modules shown in FIG. 1 may be provided as well as additional functional circuits, such as a filtering circuit for suppressing EMI (electromagnetic interference) generated by the converter 100 and/or a feedback circuit providing the controller 116 with information about a load attached to the outputs of the converter 100 and/or a current switching circuit which is controlled by the controller 116 and is configured to provide a switched current to the primary side 120 of the transformer 118.

According to various embodiments of the converter 100, the input circuit 106 may be coupled to the start-up circuit 110 such that in case that at least one of the input voltage is lower than a predetermined threshold and that the input voltage is substantially constant for a predefined time period, e.g. a time period of at least 100 ms, e.g. at least 200 ms, e.g. at least 300 ms e.g. at least 400 ms, e.g. at least 500 ms, e.g. at least 600 ms, e.g. at least 700 ms, e.g. at least 800 ms, e.g. at least 900 ms, at least 1 s; e.g. a time period in the range from about 100 ms to about 1 s, e.g. a time period in the range from about 200 ms to about 900 ms, e.g. a time period in the range from about 300 ms to about 800 ms, e.g. a time period in the range from about 400 ms to about 700 ms, electrical charges stored in the input circuit are flowing through the switch circuit to the reference potential terminal.

According to various embodiments, the converter 100 may be configured as an isolated switched mode power supply. In various embodiments, the converter may be configured as a converter selected from a group of converters including a boost converter; buck converter; boost/buck converter; and flyback converter. In accordance with various embodiments, the converter 100 can be used for converting AC voltage or DC voltage into a DC voltage. According to various embodiments of the converter 100, a DC voltage (e.g. in the range from about 50 V to about 1 kV or even more) or an AC voltage (e.g. in the range from about 85 V to about 270 V; it is to be noted that the circuit in accordance with various embodiments can be operated in a wider range such as e.g. in the range from about 50 V to about 1 kV or even more) may be applied to the one or more input terminals 102, 104 of the converter 100. It is to be understood that by virtue of Ohm's law the voltage conversion also applies in an analogous manner to a current conversion.

According to various embodiments of the converter 100, the transformer 118 may include a primary side 120 and a secondary side 122. The controller 116 may be coupled to the primary side 120 of the transformer 118 and configured to control the current flow (for example by means of a current switching circuit coupled thereto and further coupled to the primary side 120 of the transformer 118) through the primary side 120 of the transformer 118 and may include various functional modules and/or circuits. The controller 116 may, for example, include a modulation circuit configured to provide at least one switch signal to a current switching circuit coupled to the controller 116 and further coupled to the primary side 120 of the transformer, wherein the modulation circuit may be configured as a pulse width modulation (PWM) circuit or as a pulse frequency modulation (PFM) circuit. In various embodiments, the controller 116 may further include a power management circuit configured to provide power management for the controller 116 and/or a current limiting circuit. The circuit modules and/or circuits which may be provided within the controller 116 may be communicatively coupled with each other by a communication bus. Furthermore, the communication bus may be coupled to a communication interface which is provided to establish electrical contact between the modules of the controller 116 and surrounding circuitry the controller might be embedded into. The communication interface may, for example, include pins or terminals to which external leads can be coupled. The one or more pins or terminals may be dedicated, i.e. solely provided for contacting a specific circuit module within the controller 116, or they can be coupled to more than one circuit module.

In various embodiments, the controller 116 may include a plurality of discrete circuit components (e.g. an analog controller including a plurality of discrete logic gates and/or analog amplifier(s)) which may be mounted on a printed circuit board, for example, such as e.g. one or more circuits as described above, or may be configured as a programmable controller (which may be monolithically integrated on a wafer substrate) such as e.g. a microcontroller (e.g. a reduced instruction set computer (RISC) microcontroller or a complex instruction set computer (CISC) microcontroller), or a field programmable gate array (FPGA), or a programmable logic array (PLA) or any other kind of logic circuit.

In accordance with various embodiments of the converter 100, the start-up circuit 110 may include the state detection circuit 112 which is configured to detect a state in which the input circuit 106 is decoupled from the input voltage, i.e. where the first input 102 and the second input 104 are decoupled from the input voltage.

According to various embodiments of the converter 100, the input circuit 106 of the converter 100 may include one or more capacitors coupled between the first input 102 and the second input 104 of the input circuit 106, wherein the first input 102 and the second input 104 are configured to receive the input voltage, wherein the one or more capacitors are configured to store the electrical charges stored in the input circuit 106.

According to various embodiments of the converter 100, the charge pump circuit 108 coupled to the input circuit 106 may be provided in the converter 100, wherein the state detection circuit 112 may include a capacitor which is coupled to the charge pump circuit 108. The capacitor may be configured to store charges provided by the charge pump circuit. The state detection circuit 112 may further include a resistor coupled in parallel to the capacitor, wherein one contact of the resistor is connected to a reference potential. The state detection circuit 112 may further include a diode which is coupled in parallel to the capacitor.

According to various embodiments of the converter 100, the start-up circuit may be configured such that the capacitor which is provided with charges by the charge pump circuit 108 is discharged when the input voltage is lower than the predetermined threshold. The sinking of the input voltage below the predetermined voltage may represent the state in which the converter 100 is decoupled from the input voltage.

In accordance with various embodiments of the converter 100, the switch circuit 114 may include a first switch which is configured to be switched when the capacitor which is provided with charges by the charge pump circuit is discharged. The first switch may be formed as a MOSFET (metal-oxide semiconductor field effect transistor), for example as a depletion MOSFET, for example as a n-channel depletion MOSFET.

According to various embodiments of the converter 100, the switch circuit 114 may include a second switch which is coupled to the first switch such that the state of the second switch is controllable by the first switch. The second switch may be formed as a MOSFET, for example as an enrichment MOSFET, for example as a n-channel enrichment MOSFET. The second switch may be coupled between one input of the input circuit 106 and the reference potential.

According to various embodiments of the converter 100, the state detection circuit 112 may be coupled to the switch circuit 114 and may be configured to transmit a control signal to the switch circuit 114.

In accordance with various embodiments of the converter 100, the switch circuit 114 may further include a first resistor coupled between one input of the input circuit and the second switch, a second resistor coupled between the second switch and the reference potential and a diode coupled between the second resistor and the reference potential.

In accordance with various embodiments of the converter 100, the start-up circuit 110 including the state detection circuit 112 and the switch circuit 114 may be commonly integrated in one controller, for example the main controller 116 provided in the converter 100.

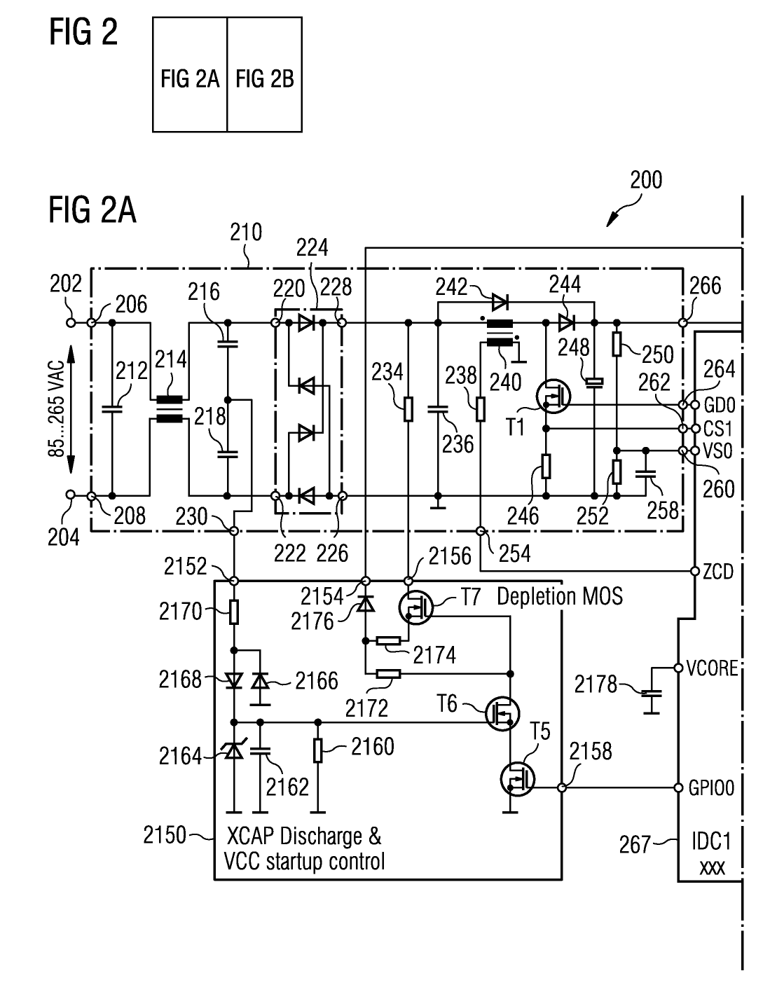

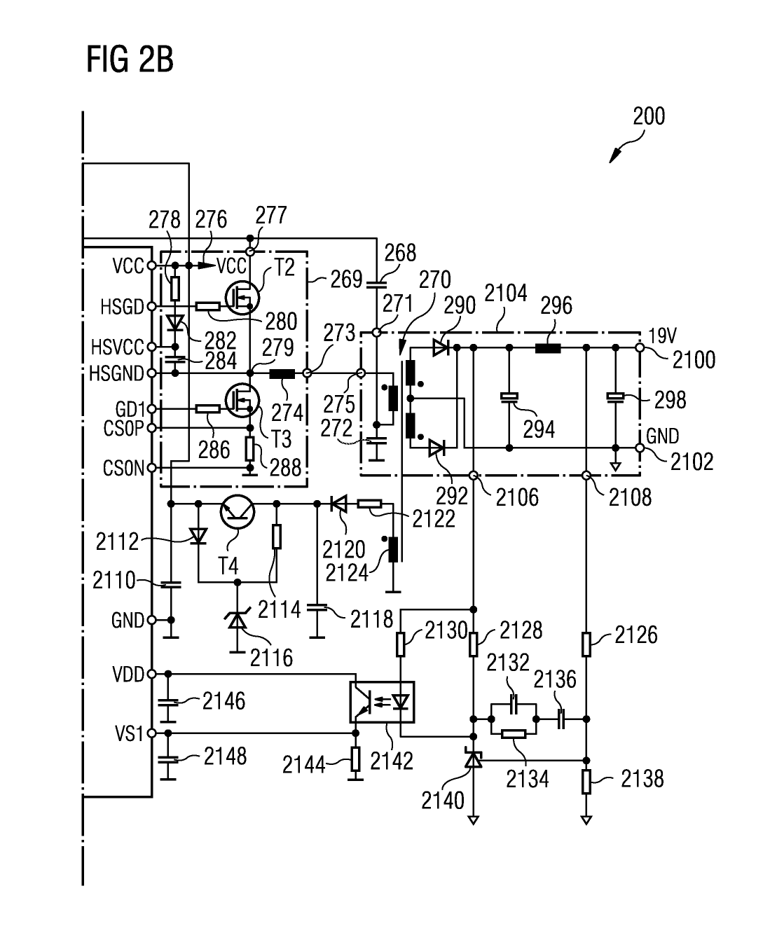

In the following, with reference to FIG. 2, an implementation of the converter 100 shown in FIG. 1 and its functionality will be described. However, it is to be noted that the specific design of the circuit displayed in FIG. 2 is only one possible implementation of many possible implementations and therefore it shall not be viewed as limiting with respect to the general concept of the converter 100 according to various embodiments. The examples and embodiments described are for illustrative purposes only and various modifications or changes in light of the general concept of the converter 100 are to be included within the spirit of this application and scope of the appended claims.

In various embodiments it is assumed that the voltage to be converted is applied to the first input terminal 202 and the second input terminal 204 of the converter 200. The first input terminal 202 and the second input terminal 204 are connected to a first input 206 and a second input 208, respectively, of the input circuit 210. The input circuit 210 may include a first capacitor 212 coupled in parallel to the first input 206 and the second input 208 of the input circuit 210 and a series arrangement of a second capacitor 216 and a third capacitor 218 also coupled in parallel to the first input 206 and the second input 208 of the input circuit 210. A first inductor 214 is coupled between the first capacitor 608 and the series arrangement of the second capacitor 216 and the third capacitor 218, wherein the first inductor 214 has a first winding and a second winding which are magnetically coupled with each other and the first winding is coupled in series between the first input 206 of the input circuit 210 and a first input 220 of a rectifying circuit 224 and the second winding is coupled in series between the second input 208 and a second input 222 of the rectifying circuit 224. The input circuit 210 is provided with a first output 230 which is coupled to a tap provided between the second capacitor 216 and third capacitor 218.

The rectifying circuit 224 includes an arrangement of four diodes which is also referred to as a full-wave bridge rectifier. The full-wave bridge rectifier is coupled between the first input 220 and the second input 222 and a first output 228 and a second output 226 of the rectifying circuit 224.

A fourth capacitor 236 is coupled in parallel between the first output 228 and the second output 226 of the rectifying circuit 224. The first output 228 of the rectifying circuit 224 is further is connected to a second output 232 of the input circuit 210 via a first resistor 234. The first output 228 of the rectifying circuit 224 is further coupled to one end of a first winding of a second inductor 240, the other end of the first winding of the second inductor 240 is coupled to a drain of a first transistor T1 and via a second diode 248 to one side of a fifth capacitor 248 and to a sixth output 226 of the input circuit 210. The is coupled to a source of a first transistor T15 by a first resistor 623. In addition to the first winding, the second inductor 240 also includes a second winding which are magnetically coupled with each other, e.g. by a ferromagnetic coil. One end of the second winding is coupled to ground, the other end is connected to a third output 254 of the input circuit 210 via a second resistor 238. The third output 254 is coupled to a terminal ZCD of the controller 267. The side of the fourth capacitor 236 and the side of the fifth capacitor 248 that are coupled to the electrical path between the first output 228 of the rectifying circuit 224 and the sixth output 226 of the input circuit 210 are further coupled to one another via a first diode 242.

The second output 226 of the rectifying circuit 224, apart from being connected to ground, is coupled to a source of the first transistor T1 via a third resistor 246, to the other side of the fifth capacitor 248, to the sixth output 226 of the input circuit 210 via a series arrangement of a fifth resistor 252 and a sixth resistor 250 and to a fourth output 260 of the input circuit 210 via a sixth capacitor 258. The fourth output 260 is coupled to a terminal VS0 of the controller 267. A tap between the third resistor 246 and the source of the first transistor T1 is coupled to a fifth output 262 of the input circuit 210. The fifth output 262 is coupled to a CS1 terminal of the controller 267. A gate of the first transistor T1 is coupled to a third output 264 of the input circuit 210. The third output is coupled to a GD0 terminal of the controller 267.

The sixth output 266 of the input circuit 210 is coupled to a first input 277 of a current switching circuit 269. Within the current switching circuit 269, the first input 277 is coupled to a drain of a second transistor T2. A source of the second transistor T2 is coupled to a drain of a third transistor T3 via a first node 279. A source of the third transistor T3 is coupled to one contact of a ninth resistor 288, the other contact of which is coupled to ground. A terminal CS0N of the controller 267 is coupled to the electrical path between the ninth resistor 288 and ground. The source of the third transistor T3 is further coupled to a terminal CS0P of the controller 267. The gate of the second transistor T2 is coupled to a terminal HSGD of the controller 267 via a seventh resistor 280. The gate of the third transistor T3 is coupled to a terminal GD1 of the controller 267 via an eighth resistor 286. The first node 279 is further coupled to a first output 273 of the current switching circuit 269 via a third inductor 274 and to a terminal HSGND of the controller 269. One end of an seventh capacitor 284 is coupled to the first node 279, the other end being coupled to a terminal HSVCC of the controller 267 and to a terminal VCC of the controller 267 via a third diode 282 and a sixth resistor 278 arranged in series.

The first output 273 of the current switching circuit 269 is coupled to a second input 275 of a transforming circuit 2104. The transforming circuit 2104 is further provided with a first input 271 to which the sixth output 266 of the input circuit 210 is coupled via an eighth capacitor 268. The first input 271 of the transforming circuit is coupled to ground via a ninth capacitor 272. A first winding of a transformer 270 on its primary side is coupled between the first input 271 and the second input 275 of the transforming circuit 2104. The primary side of the transformer 270, e.g. the first winding, is magnetically coupled to its secondary side which is formed by a second and a third winding of the transformer 270. One end of the second winding on the secondary side of the transformer 270 is coupled to a first output 2100 of the transforming circuit 2104 via a fifth diode 290 and a fourth inductor 296 arranged in series. One end of the third winding on the secondary side of the transformer 660 is coupled to the electrical path between the fifth diode 290 and the fourth inductor 296 via a fourth diode 292. One side of an tenth capacitor 294 is coupled to the electrical path between the fifth diode 290 and the fourth inductor 296, the other side of the tenth capacitor 294 is coupled to a tap arranged between the second winding and the third winding on the secondary side of the transformer 270 and is further coupled to a second output 2102 of the transforming circuit 2104. An eleventh capacitor 298 is coupled between the first output 2100 and the second output 2102 of the transforming circuit 2104. The second output 2102 is further connected to signal ground. The signal ground can be independent of ground reference or it can be connected to ground. The transforming circuit 2104 further has a third output 2108, a fourth output 2106, wherein the third output 2108 is coupled to the electrical path between the first output 2100 of the transforming circuit 2104 and the fourth inductor 296 and the fourth output 2106 is coupled to the electrical path between the fourth inductor 296 and the fifth diode 290.

A fifth inductor 2124 is magnetically coupled to the first winding of the primary side and to the second and third winding of the secondary side of the transformer 270. One end of the fifth inductor 2124 is connected to ground, the other end is coupled to a collector of a fourth transistor T4 via a tenth resistor 2122 and a sixth diode 2120. An emitter of the fourth transistor T4 is coupled to the terminal VCC of the controller 267 and further to a terminal GND of the controller 267 via a twelfth capacitor 2110, the terminal GND of the controller 267 is coupled to ground. A base of the fourth transistor T4 is coupled to its emitter via a seventh diode 2112, to its collector via an eleventh resistor 2114 and to ground via an eighth diode 2116. One side of a thirteenth capacitor 2118 is coupled to ground, the other side being coupled to the electrical path between the sixth diode 2120 and the collector of the fourth transistor T4.

The converter 200 further includes the start-up circuit 2150. A terminal GPIO0 of the controller 267 is coupled to a third input 2158 of the start-up circuit. Within the start-up circuit 2150, a gate of a fifth transistor T5 is coupled to the third input 2158 of the start-up circuit. A source of the fifth transistor T5 is connected to ground, a drain of the fifth transistor T5 is coupled to a source of a sixth transistor T6, which in various embodiments acts as a comparator and thus as a state detection circuit comparing the generated state from e.g. the charge pump circuit with a predefined threshold, e.g. the internal gate/source threshold of the sixth transistor T6 (or e.g. the base/emitter threshold of the sixth transistor T6 in case it is implemented as a bipolar transistor). A gate of the sixth transistor T6 is coupled to the first input 2152 of the start-up circuit 2150 via a series arrangement of an eleventh diode 2168 and an eighteenth resistor 2170. The first input 2152 of the start-up circuit 2150 is coupled to the first output 230 of the input circuit 210. One contact of a twelfth diode 2166 is coupled to the electrical path between the eleventh diode 2168 and the eighteenth resistor 2170, the other contact is connected to ground. One contact of a tenth diode 2164, one side of an eighteenth capacitor 2162 and one contact of a seventeenth resistor 2160 are coupled to the electrical path between the gate of the sixth transistor T6 and the eleventh diode 2168. The other contact of the tenth diode 2164, the other end of the eighteenth capacitor 2162 and the other contact of the seventeenth resistor 2160 is coupled to ground. A drain of the sixth transistor T6 is coupled to a gate of a seventh transistor T7. A drain of the seventh transistor T7 is coupled to a second input 2156 of the start-up circuit 2150. The second input 2156 is of the start-up circuit 2150 is coupled to the second output 232 of the input circuit. A source of the seventh transistor T7 is coupled to its gate and the drain of the sixth transistor T6 via a series arrangement of a twentieth resistor 2174 and a nineteenth resistor 2172. A thirteenth diode 2176 is coupled between the twentieth resistor 2174 and a first output 2154 of the start-up circuit 2150. The first output 2154 of the start-up circuit 2150 is coupled to the terminal VCC of the controller 267. The VCC terminal of the controller 267 is further connected to a power rail. A nineteenth capacitor 2178 is coupled between ground and a terminal VCORE of the controller 267.

The above description of the converter 200 is based on an actual exemplary implementation. It should be noted that several devices of the converter circuit mentioned can be exchanged by other equivalent devices. For example, the optocoupler including a phototransistor and a light emitting diode can be replaced by any other device being able to convert an electrical input signal into a light signal and further having any kind of a photo sensor for detecting the generated light. The photo sensor may, upon detection of generated light, generate electric energy itself or alter the electric current flowing therethrough. Therefore, for example, the photo sensor might be a be a photo resistor, a photodiode, a phototransistor, a silicon-controlled rectifier (SCR) or a triac, the device being able to convert an electrical input signal into a light signal might be a near-infrared light emitting diode (LED). In general, in various embodiments, a galvanically isolated element or galvanically isolated structure, component or device may be provided for transferring signals from one side of the converter 200 to the other side of the converter, e.g. transformers, optocouplers, piezotransformers, coreless transformer circuits and the like.

The transistors used in the exemplary embodiment of the converter 200 include BJTs (bipolar junction transistors), whenever contacts are labelled emitter, collector and base, and MOSFETs (metal-oxide-semiconductor field-effect transistor), whenever contacts are labelled drain, source and gate. It should be noted that devices referred to as transistors in the course of the description can be replaced by equivalent switching devices that can be used to switch and/or amplify electronic signals. In the specific example of the converter 200 according to various embodiments shown in FIG. 2, the first transistor T1, the second transistor T2, the third transistor T3, the fifteenth transistor T5 and the sixth transistor T6 are formed as n-channel enrichment MOSFETs. The seventh transistor T7 is formed as a n-channel depletion MOSFET and the fourth transistor T4 is formed as a npn bipolar transistors.

In the following, the functionality of the converter 200 will be described with focus on the functionality of the start-up circuit 2150. It is to be noted that the specific design of the whole circuit displayed in FIG. 2 is only one possible of very many embodiments and therefore it shall not be viewed as limiting concerning the general concept of the converter according to various embodiments. The examples and embodiments described are for illustrative purposes only and various modifications or changes in light of the general concept of the converter according to various embodiments are to be included within the spirit of this application and scope of the appended claims.

In various embodiments it is assumed that the voltage to be converted is applied to the first input terminal 202 and the second input terminal 204 of the converter. The start-up circuit 2150 is provided to start the controller 267 after it has been shut down and to provide a discharge path for the X-caps, for example including the first capacitor 212 and the fourth capacitor 236. The controller 267 might be shut down in order to optimize power consumption during a low load state, illustratively representing a state in which no load is coupled to the outputs of the converter 200. The X-caps have to be discharged once the converter 200 is disconnected from input voltage. In the embodiment of the converter 200 shown in FIG. 2 those functionalities (start-up functionality and X-cap discharge functionality) are combined in one circuit, the start-up circuit 2150. One advantage may be seen in the fact that only one high voltage switch (represented by the transistor T7 in the embodiment of the converter shown in FIG. 2) needs to be used and the combination of the mentioned functionalities allows for a more compact design of the converter 200.

The detection of a state in which the input circuit is decoupled from the input voltage may be performed via the charge pump circuit which may including the second capacitor 216, the third capacitor 218, the eighteenth resistor 2170, the eleventh diode 2168 and the twelfth diode 2166. The charge pump circuit may be coupled to the sense circuit which may include the tenth diode 2164, the eighteenth capacitor 2162 and the seventeenth resistor 2160. The charge pump circuit may generate a voltage across the eighteenth capacitor 2162 which may be applied to the gate of the sixth transistor T6. The sixth transistor T6 may be part of the switch circuit which may further include the fifth transistor T5 and the seventh transistor T7. Upon disconnection of the converter 200 from input voltage, the charge pump circuit discontinues providing charges to the eighteenth capacitor 2162. The eighteenth capacitor 2162 discharges over time and at some point the potential applied to the sixth transistor T6 drops below a threshold voltage of the transistor and the sixth transistor becomes non conducting. In consequence, the seventh transistor T7 is activated, i.e. made conductive, and a discharge path for the X-caps of the converter 200 is provided. The X-caps may be discharged through the first resistor 234, the seventh transistor T7, the twentieth resistor 2174, the thirteenth diode 2176 and further be conducted via a VCC loading path, i.e. the electrical path coupled to the first output of the start-up circuit 2150. During the process of disconnecting the converter 200 from input voltage the functionality of the start-up circuit is dominated by the X-cap discharge functionality.

During an initial start-up of the converter 200 when an input voltage is applied to the first input 202 and the second input 204 of the converter 200, the controller 267 is inactive. The signal at the terminal GPIO0 is low, both the fifth transistor T5 and the sixth transistor T6 are deactivated (i.e. not in a conducting state) and the gate of the seventh transistor T7 is floating. The sixth capacitor 2118 and twelfth capacitor 2110 are charged and the controller is started. During the start-up phase the voltage of the eighteenth capacitor 2162 in the start-up circuit 2150 is slowly increasing and at some point the voltage at the gate of the sixth transistor T6 exceeds a threshold voltage of the transistor and the sixth transistor T6 becomes conducting. After the controller 267 has been started and the converter 200 has entered its normal operating mode, the seventh transistor T7 is deactivated by means of switching off the fifth transistor T5 (i.e. becomes non-conducting).

The normal operating state (or mode) corresponds to a state of the converter 200 where it converts an input AC- or DC-voltage into a desired DC-voltage. This state is initiated after the start-up process has finished and the controller 267 has been started.

A voltage applied to the inputs of the input circuit 210 may be filtered by the capacitors coupled in parallel to the first input 206 and second input 208 of the input circuit 210, for example by the first capacitor 212, and by the first inductor 214 acting as a choke. Those elements of the input circuit 210 are configured to provide a filtered (with respect to higher frequencies) voltage for further processing within the converter 200. In addition, the filtering functionality may also provide suppression of high frequency current components which might leave the converter 200 through its first input terminal 202 and the second input terminal 204 into the AC wiring connected thereto and thereby cause interferences on other devices.

The rectifying circuit 224 including four diodes in a bridge arrangement is configured to provide the output voltage of one polarity for input voltage of both polarities. It should be noted that the rectifying circuit 224 is provided for transforming an AC voltage into a DC voltage and therefore may be omitted, for example, when the converter 200 is used as a DC-DC converter, i.e. when a DC voltage is applied to the first input terminal 204 and the second input terminal 204 of the converter 200.

The controller 267 may be provided with a zero current detection functionality. The second winding of the second inductor 240 and the second resistor 238 coupled in series to the terminal ZCD of the controller 267 form an optional circuit module which may be used by the controller 267 to detect whether current is flowing (amount and direction) between the first input 206 and the sixth output 266 of the input circuit 210.

During the normal operating mode, a AC (or DC) voltage is applied to the converter 200 and subsequently may be filtered by the filtering elements mentioned above and further rectified by the rectifying circuit 224. The DC voltage is then applied to the first input 277 of the current switching circuit 269. The current switching circuit 269 is controlled by the controller 267 to provide a switched DC current at the first output 273 of the current switching circuit 269 which is then applied to the second input 275 of the transforming circuit 2104. The switched current is derived from the DC current applied to the first input 277 of the current switching circuit 269 by means of the second transistor T2 and the third transistor T3 which may be switched out of phase, i.e. when one is conducting, the other one is not conducting. When the second transistor T2 is set into a conducting state, the current provided at the first output 273 corresponds to the current provided to the current switching circuit 269 at its first input 277. When the third transistor T3 is set into a conducing state, a connection between ground and the first output 273 is established. By adjusting the switching cycle of the second transistor T2 and the third transistor T3, the switched current provided at the second input 275 of the transforming circuit 2104 induces a voltage in the second and the third winding of the transformer 660 on its secondary side. The average value of this voltage is the DC voltage that is provided at first and second output 2100, 2102 of the transforming circuit 2104 and may be fed to an external load which requires a DC voltage for operation.

During normal operating mode of the converter 200, the current and/or voltage demanded at output of the transforming circuit 2104 (and thereby at the output of the converter 200) is sampled and provided at the third output 2108 and fourth output 2106 of the transforming circuit 2104. The sampled values may correspond to a scaled voltage and/or current on the basis of which a corresponding signal is transmitted to the controller 267 via the optocoupler 2142. The controller 267 may evaluate the signal received from the optocoupler 2142 and may for example adjust the switching cycle of the switch current to lower or raise the DC-voltage provided at the outputs 2100, 2102 of the converter 200. In this sense, the signal transmitted by the optocoupler 2142 may be used as a feedback signal.

According to various embodiments, a converter may be provided where the start-up circuit is fully integrated into the controller.

In an implementation of these embodiments, the switch circuit may include a common switch, which is coupled the input circuit.

In another implementation of these embodiments, the start-up circuit may be configured to provide a switch signal to the common switch. The common switch may be formed as a MOSFET, for example as a depletion MOSFET.

According to yet another implementation of these embodiments, the switch circuit may include a discharge switch coupled between the terminal of the start-up circuit and the reference potential, wherein the discharge switch is controlled by the state of the detection circuit.

According to yet another implementation of these embodiments, the state detection circuit may be coupled to the terminal of the start-up circuit and may be configured to sample the input voltage.

In yet another implementation of these embodiments, the sampled input voltage my correspond to a scaled down input voltage.

In yet another implementation of these embodiments, a switch may be provided between the terminal of the start-up circuit and the state detection circuit and the switch may be controlled by the start-up circuit.

According to yet another implementation of these embodiments, the state detection circuit may be configured to detect a state of the input voltage being lower than the predetermined threshold voltage, wherein that state is characterized by at least two consecutive input voltage samples having the same value.

According to yet another implementation of these embodiments, the state detection circuit is coupled to the switch circuit and is configured to transmit a control signal to the switch circuit.

In yet another implementation of these embodiments, the terminal of the start-up circuit may be coupled to a power supply terminal of the controller.

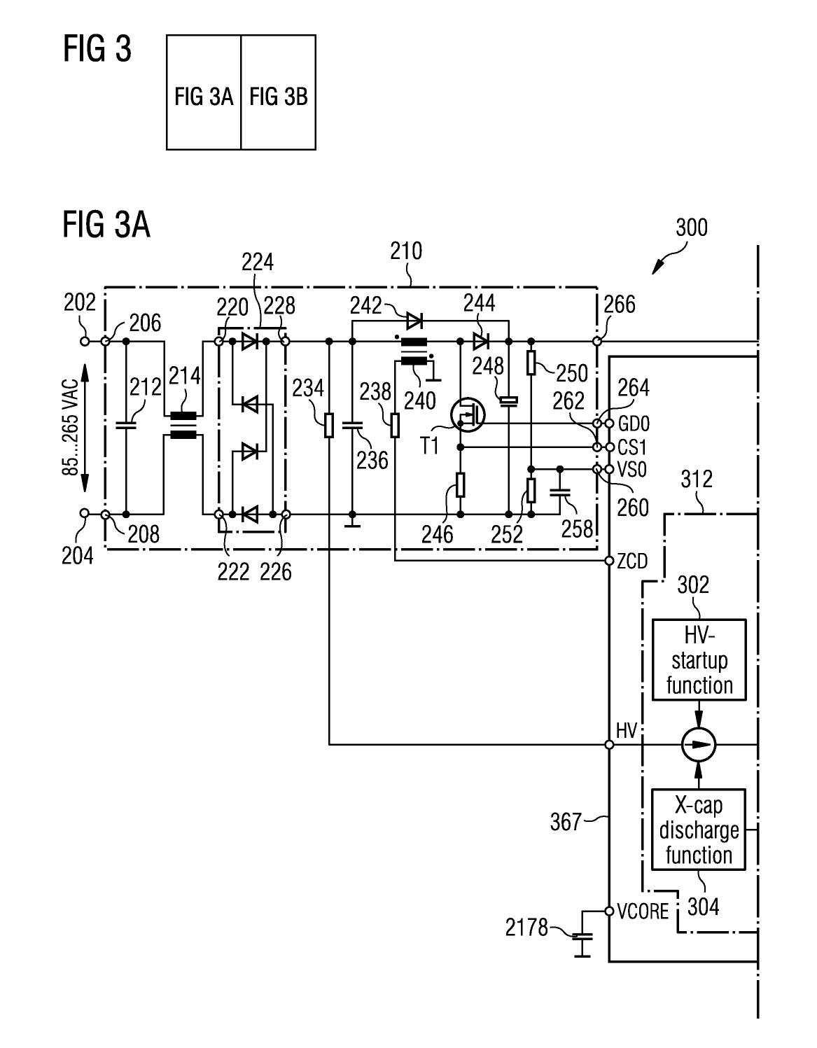

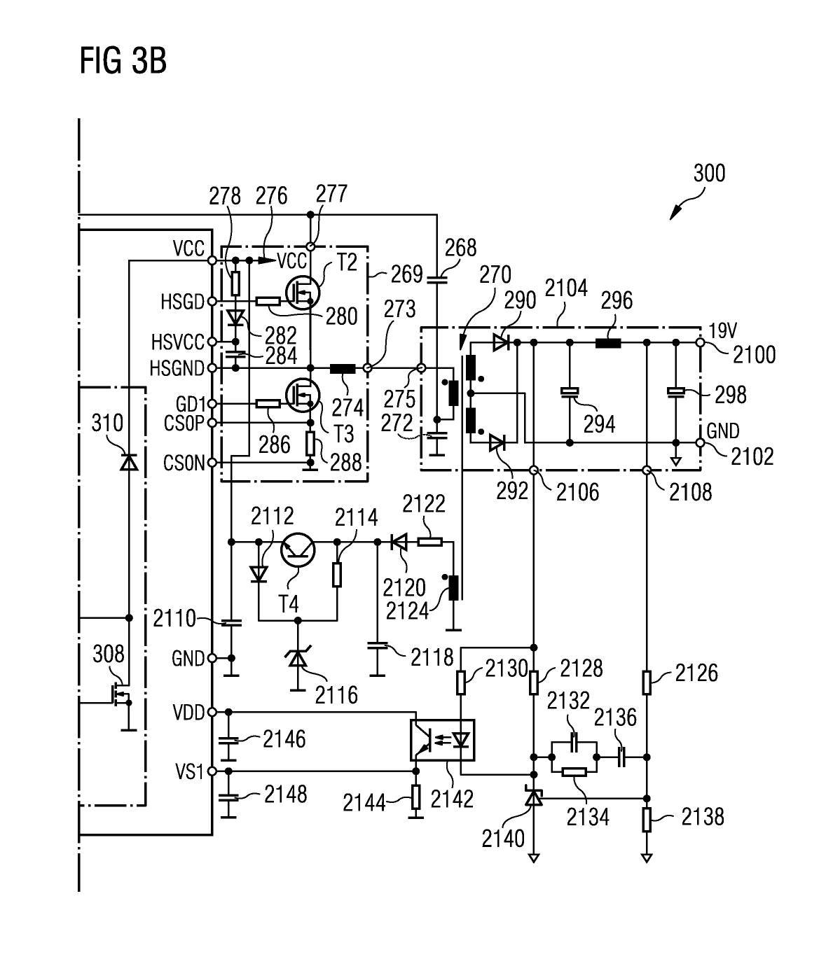

An implementation of the converter according to various embodiments is shown in FIG. 3. The controller 367 with the implemented start-up circuit 312 is described. An actual implementation of the controller 367 in accordance with various embodiments will be given further below.

The circuitry of the converter 300 shown in FIG. 3 is similar to the circuitry of the converter 200 shown in FIG. 2. All elements shared by both embodiments (shown in FIG. 2 and FIG. 3) are labelled with the same reference numbers and in the following will not be described again in the context of the converter 300 shown in FIG. 3. Only differences of the converter 300 with respect to the converter 200 shown in FIG. 2 will be described.

The input circuit 310 of the converter 300 in FIG. 3 can be obtained from the input circuit 210 of the converter 200 shown in FIG. 2 by leaving out the start-up circuit 2150 as it is shown in FIG. 2 and implementing it into the controller 367. Furthermore, the second capacitor 214 and the third capacitor 218 may be omitted, such that the first output 230 of the input circuit 210 may also be left out. The controller 367 of the embodiment of the converter 300 shown in FIG. 3 is then provided with a terminal HV to which the second output 232 of the input circuit 310 is coupled, the terminal GPIO0 is not used. In the exemplary embodiment of the converter 300 in FIG. 3 the second output 232 of the input circuit 310 coupled to the terminal HV of the controller 367 provides a discharge path for the X-caps including the first capacitor 212 and the fourth capacitor 236. The second output 232 of the input circuit 310 coupled to the terminal HV of the controller 367 also replaces the left out first output 230 of the input circuit 210 of the converter 200 of FIG. 2 in the sense that it provides a signal to the controller 367 from which the controller 367 can detect a state in which the converter 300 is disconnected from input voltage.

The start-up circuit 312 is now integrated in the controller 367 in the converter 300 shown in FIG. 3. In various embodiments, the controller in general may include a plurality of discrete circuit components (which may be mounted on a printed circuit board, for example), such as e.g. one or more circuits as described above, or may be configured as a programmable controller (which may be monolithically integrated on a wafer substrate) such as e.g. a microcontroller (e.g. a reduced instruction set computer (RISC) microcontroller or a complex instruction set computer (CISC) microcontroller), or a field programmable gate array (FPGA), or a programmable logic array (PLA) or any other kind of logic circuit. The functionality of the start-up circuit 312 may be implemented within the controller 367 in a discrete form or in a programmable form.

The controller 367 may have a start-up functionality module 302 and a X-cap discharge functionality module 304. Both modules may make use of a high voltage switch (not displayed) which is coupled between the terminal HV of the controller 367 and the modules. A current source 306 is coupled to the terminal HV of the controller 367 and via a diode 310 to the VCC terminal of the controller 367. The terminal HV of the controller 367 is internally coupled to ground via the current source 306 and a transistor 308, e.g. an n-channel enrichment transistor.

The X-cap discharge functionality module 304 may be configured to switch off the current source 306 upon detection of a state in which the input voltage is disconnected from the converter 300 and in addition may be configured to activate the transistor 308, such that the X-caps in the input circuit 310 can be discharged via the terminal HV of the controller 367 to ground.

The start-up functionality module 302 may be configured to switch on the current source 306 upon detection of a state in which the input voltage is connected to the converter 300, i.e. the controller 367 needs to be activated.

The integration of the start-up circuit 312 into the controller 367 may offer an optimization of system costs. Simultaneously, the average power loss may be further minimized by implementing an appropriate state detection circuit (not displayed in FIG. 3). As in the embodiment of the converter 200 shown in FIG. 2, only one integrated high voltage switch (not displayed in FIG. 3) may be used by the integrated start-up circuit in the embodiment of the converter 300 shown in FIG. 3.

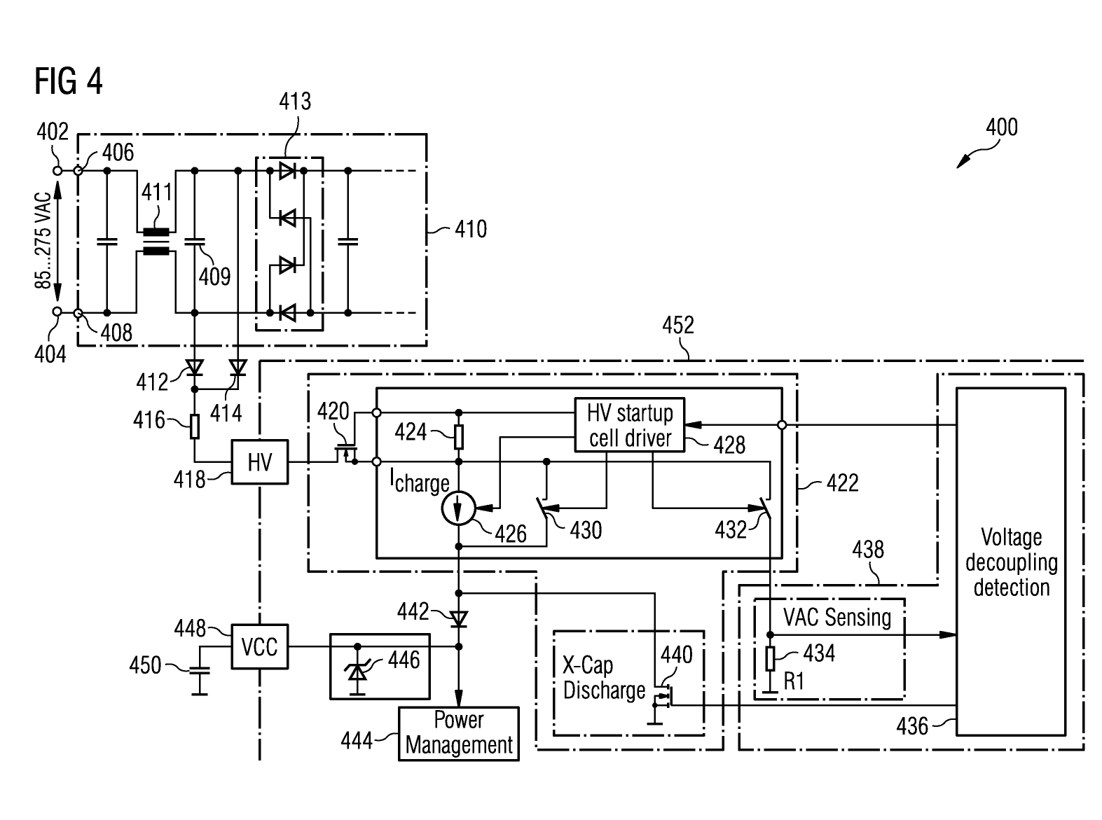

FIG. 4 shows an exemplary implementation of the controller 367 included in the converter 300 of FIG. 3 in accordance with various embodiments. Only the relevant part of the converter 400 is displayed in FIG. 4. In analogy to the implementations of the converter shown in FIG. 2 and FIG. 3, the first input 402 and the second input 404 of the converter 400 are coupled to the first input 406 and the second input 408 of the input circuit 410. A first capacitor 409 of the input circuit 410 is coupled in parallel to the first input 406 and the second input 408 of the input circuit 410, upstream of the rectifying circuit 413 and downstream of the primary and secondary winding of a first inductor 411 of the input circuit 410. One side of the first capacitor 411 is coupled to the terminal HV of the controller 452 via a first diode 412 and a first resistor 416, the other side of the first capacitor 411 is also coupled to the terminal HV of the controller 452 via a second diode 414 and the first resistor 416. (The rest of the input circuit 410 will not be described as it corresponds to the input circuit 210 in FIG. 2, for example).

The terminal HV of the controller 452 is the interface through which the start-up circuit including the switch circuit 422, the state detection circuit 438 and various other components and/or elements provided in the controller 452 communicate with the input circuit 410. A drain of a common switch 420, for example a depletion n-channel MOSFET, is coupled to the terminal HV of the controller. A source of the common switch is coupled to one end of a first switch 430 and one end of a second switch 432. A gate of the common switch is coupled to a control output of a start-up cell driver 428 and to the source of the common switch 420 via a third resistor 424. The source of the common switch 420 is further coupled to the terminal VCC of the controller 452 via a current source 426 and a third diode 442 and to a power management module 444 of the controller 452. Inside the controller, a fourth diode 446 is coupled between the terminal HV of the controller 452 and ground. Outside the controller 452, the terminal HV of the controller 452 is coupled to one side of a second capacitor 450, the other side of which is connected to ground.

The start-up driver cell 428 is provided with further control outputs which are coupled to the current source 426, to the first switch 430 and to the second switch 432, respectively. The other end of the first switch 430 is coupled to the electrical path between the current source 426 and the third diode 442. The other end of the second switch 432 is coupled to ground via a third resistor 434 and to a voltage decoupling detection module 436 which is part of the state detection circuit 438. One control output of the voltage decoupling detection module 436 is coupled to the start-up cell driver 428, another control output of the voltage decoupling detection module 436 is coupled to a gate of a fourth switch included in the switch circuit 422, for example an enrichment n-channel MOSFET. A drain of the fourth switch is coupled to the electrical path between the other end of the first switch 430 and the third diode 442, a source of the fourth switch 440 is coupled to ground.

In the following, the functioning of the integrated start-up circuit will be described. The integrated implementation of the start-up circuit offers both start-up functionality of the controller and X-cap discharge functionality. The voltage at the first input 406 and/or the second input 408 of the input circuit 410 is sampled by the voltage decoupling detection module 436. The sampling is performed in a cycled manner, wherein the second switch 432 is controlled by the start-up cell driver 428. During periods, where the second switch 432 is closed, the voltage decoupling detection module 436 receives samples of the input voltage which are scaled by means of a voltage divider in the form of the third resistor 434. A state in which the converter 400 is decoupled from input voltage is detected, when the values of the sampled voltage do not change over time. In other words, a state of the converter 400 in which it is decoupled from input voltage is characterized by several, for example two, three or five, consecutive input voltage samples having equal values. When the state in which the converter 400 is decoupled from input voltage is detected, the voltage decoupling detection module 436 may transmit a control signal to the start-up cell driver 428. In consequence, the start-up cell driver 428 may transmit a control signal to the common switch, which may then be made conductive, to the second switch 430, which may then be closed, and to the current source 426, which may then be deactivated. In addition, the voltage decoupling detection module 436 may transmit a control signal to the gate of the fourth switch 440, whereby the fourth switch 440 is made conductive. In effect, a discharge path leading through the terminal HV of the controller 452, the common switch 420, the second switch 430 and the fourth switch 440 is then provided for charges stored on the X-caps, e.g. the first capacitor 409 in the input circuit 410.

Each time the input voltage is sampled by the voltage decoupling detection module 436, i.e. a conducting path is provided between the first input 406 or the second input 408 of the input circuit 410 and ground (connected to the third resistor 434), a small amount of power is lost. However, the average power loss which corresponds to the power consumption of the voltage decoupling detection module 436 due to a conducting path between one of the inputs of the converter 400 and ground can be minimized by choosing the sampling rate to be sufficiently low, for example 100 Hz, and also by choosing the sampling duration to be sufficiently low. In doing so, the average power loss due to the sampling process can be reduced to values below 1 Milliwatt.

When power losses are considered, it is to be noted that the first X-cap capacitor which is present in all the presented implementations of the converter according to various embodiments has a power loss of approximately 50-60 Milliwatts.

The above description of the converter 400, the controller 452 and of the functioning thereof is based on an exemplary implementation. It should be noted that various modifications can be made without departing from the underlying inventive idea of the converter according to various embodiments. For example, the fourth switch 440 is optionally provided, when enhanced reliability is desired. The fourth switch 440 further reduces the load on the VCC loading path and provides a faster discharge. However, it is an optional element can hence can be omitted without changing the principle of operation of the converter 400 shown in FIG. 4. Also, various elements, such as stabilizing capacitors or protective diodes can be added without changing the principle of operation of the converter 400 shown in FIG. 4. For example, a further diode could be coupled in parallel between the second capacitor 450 and ground.

In accordance with a further implementation of further embodiments, a converter is provided which may include a controller configured to control the current flow through the converter, a circuit configured to start the controller of the converter having a switch, wherein the switch is coupled to a reference potential terminal, an input circuit coupled to an input voltage, wherein the input circuit is coupled to the circuit such that in case the input circuit is decoupled from the input voltage, electrical charges stored in the input circuit are discharged through the switch to the reference potential terminal.

In accordance with another implementation of these embodiments, the converter may be configured as an isolated switched mode power supply.

In accordance with yet another implementation of these embodiments, the converter may further include a transformer having a first side and a second side, wherein the first side is coupled to the controller.

In accordance with yet another implementation of these embodiments, the circuit configured to start the controller further may further include a state detector configured to detect a state in which the input circuit is decoupled from the input voltage.

In accordance with yet another implementation of these embodiments, the switch and the state detector which are included in the circuit configured to start the controller may be commonly integrated in one controller.

In accordance with yet another implementation of these embodiments the input circuit may further include a first input and a second input configured to receive the input voltage, at least one capacitor coupled between the first input and a second input, wherein the at least one capacitor is configured to store the electrical charges stored in the input circuit.

In accordance with yet another implementation of these embodiments the converter may further include a charge pump coupled to the input circuit and the state detector, wherein the charge pump is coupled to a sense capacitor comprised by the state detector circuit configured to store charges provided by the charge pump.

In accordance with yet another implementation of these embodiments the state detector may be configured such that the sense capacitor is discharged when the input circuit is decoupled from the input voltage.

In accordance with yet another implementation of these embodiments the state detector may include a resistor coupled in parallel to the sense capacitor, wherein the resistor is configured to provide a discharge path for the sense capacitor to a reference potential.

In accordance with yet another implementation of these embodiments the state detector may further include a diode which is coupled in parallel to the sense capacitor.

In accordance with yet another implementation of these embodiments the switch may include a first switch configured to be switched when the sense capacitor of the state detector is discharged.

In accordance with yet another implementation of these embodiments the state detector may be configured to transmit a signal to the switch.

In accordance with various embodiments, a circuit is provided including a state detection circuit coupled to a first input of the circuit and including a first switch, wherein the state detection circuit is configured to control the state of the first switch depending on a signal applied to the first input of the circuit; a switch circuit including a second switch which is coupled between a second input of the circuit and a first output of the circuit and further including a third switch which is coupled between the first switch and a reference potential, wherein the state of the third switch is controllable by a signal received at a third input of the circuit; wherein the second switch is configured such that its state is controllable by the first switch and the third switch.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A converter comprising:
a start-up circuit comprising a switch circuit coupled to a reference potential terminal;
an input circuit coupled to an input voltage;
wherein the input circuit is coupled to the start-up circuit such that in case that at least one of the input voltage is lower than a predetermined threshold and that the input voltage is substantially constant for a predefined time period, electrical charges stored in the input circuit are flowing through the switch circuit to the reference potential terminal.

2. The converter of claim 1,
wherein the converter is configured as an isolated switched mode power supply.

3. The converter of claim 1, further comprising:
a transformer comprising a primary side and a secondary side;
a controller coupled to the primary side of the transformer and configured to control the current flow through the primary side of the transformer.

4. The converter of claim 1,
wherein the start-up circuit further comprises:
a state detection circuit configured to detect a state in which the input circuit is decoupled from the input voltage.

5. The converter of claim 4,
wherein the start-up circuit comprising the switch circuit and the state detection circuit is commonly integrated in one controller.

6. The converter of claim 1,
wherein the input circuit comprises one or more capacitors coupled between a first input of the input circuit and a second input of the input circuit, wherein the first input and the second input are configured to receive the input voltage, wherein the one or more capacitors are configured to store the electrical charges stored in the input circuit.

7. The converter of claim 4, further comprising:
a charge pump circuit coupled to the input circuit;
wherein the state detection circuit comprises a capacitor coupled to the charge pump circuit and configured to store charges provided by the charge pump circuit.

8. The converter of claim 7,
wherein the start-up circuit is configured such that the capacitor which is provided with charges by the charge pump circuit is discharged when the input voltage is lower than the predetermined threshold.

9. The converter of claim 4,
wherein the state detection circuit further comprises a diode which is coupled in parallel to the capacitor.

10. The converter of claim 7,
wherein the switch circuit comprises a first switch which is configured to be switched when the capacitor which is provided with charges by the charge pump circuit is discharged.

11. The converter of claim 10,
wherein the switch circuit comprises a second switch, wherein second switch is coupled to the first switch such that the state of the second switch is controllable by the first switch.

12. The converter of claim 5,
wherein the state detection circuit is coupled to the switch circuit and is configured to transmit a control signal to the switch circuit.

13. A converter comprising:
a controller configured to control the current flow through the converter;
a circuit configured to start the controller of the converter comprising a switch,
wherein the switch is coupled to a reference potential terminal;
an input circuit coupled to an input voltage;
wherein the input circuit is coupled to the circuit such that in case the input circuit is decoupled from the input voltage, electrical charges stored in the input circuit are discharged through the switch to the reference potential terminal.

14. The converter of claim 13,
wherein the converter is configured as an isolated switched mode power supply.

15. The converter of claim 13, further comprising:
a transformer comprising a first side and a second side;
wherein the first side is coupled to the controller.

16. The converter of claim 13,
wherein the circuit configured to start the controller further comprises a state detector configured to detect a state in which the input circuit is decoupled from the input voltage.

17. The converter of claim 13,
wherein the switch and the state detector comprised by the circuit configured to start the controller are commonly integrated in one controller.

18. The converter of claim 13,
wherein the input circuit comprises:
a first input and a second input configured to receive the input voltage;
at least one capacitor coupled between the first input and a second input, wherein the at least one capacitor is configured to store the electrical charges stored in the input circuit.

19. The converter of claim 16, further comprising:
a charge pump coupled to the input circuit and the state detector;
wherein the charge pump is coupled to a sense capacitor comprised by the state detector circuit configured to store charges provided by the charge pump.

20. The converter of claim 19,
wherein the state detector is configured such that the sense capacitor is discharged when the input circuit is decoupled from the input voltage.

21. The converter of claim 19,
wherein the state detector comprises a resistor coupled in parallel to the sense capacitor, wherein the resistor is configured to provide a discharge path for the sense capacitor to a reference potential.

22. The converter of claim 16,
wherein the state detector further comprises a diode which is coupled in parallel to the sense capacitor.

23. The converter of claim 19,
wherein the switch comprises a first switch configured to be switched when the sense capacitor of the state detector is discharged.

24. The converter of claim 16,
wherein the state detector is configured to transmit a signal to the switch.

25. A circuit, comprising:
a state detection circuit coupled to a first input of the circuit and comprising a first switch, wherein the state detection circuit is configured to control the state of the first switch depending on a signal applied to the first input of the circuit;
a switch circuit comprising a second switch which is coupled between a second input of the circuit and a first output of the circuit and further comprising a third switch which is coupled between the first switch and a reference potential,
wherein the state of the third switch is controllable by a signal received at a third input of the circuit;
wherein the second switch is configured such that its state is controllable by the first switch and the third switch.
